(19) United States
(12) Patent Application Publication
(10) Pub. No.: US 2025/0115108 A1
(43) Pub. Date: Apr. 10, 2025

(54) SPACE OPTIMIZATION OF CHASSIS DESIGN FOR BATTERIES USED IN ELECTRIC VEHICLES

(71) Applicant: A&C FUTURE, INC., Newport Beach, CA (US)

(72) Inventors: Yenchang Lin, Irvine, CA (US); Jose Carrasco, Newport Beach, CA (US); Pengcheng Wang, Irvine, CA (US); Ju Gao, Newport Beach, CA (US); Shoue Chen, Irvine, CA (US); Han Qin, Newport Beach, CA (US); Jiayang Qin, Newport Beach, CA (US)

(21) Appl. No.: 18/483,551

(22) Filed: Oct. 10, 2023

(51) Int. Cl. B60K 1/04; B60L 50/64

(52) U.S. Cl. CPC B60K 1/04; B60L 50/64; B60K 2001/0438

(57) ABSTRACT

An electric vehicle chassis includes multiple battery compartments specifically arranged therein. The chassis can include a main structure extending longitudinally along a length of the electric vehicle which it supports. The main structure can include a first, upper main structure battery compartment. A lower main structure frame can be disposed below the first, upper main structure battery compartment to provide a second, lower main structure battery compartment. Side battery compartments can be attached to opposite sides of the main structure frame to provide third and fourth, side battery compartments. Thus, the vehicle chassis can provide four distinctly positioned battery compartments for the placement of batteries for the electric vehicle, providing more battery storage spaces than conventional same-class electric vehicles.

### BACKGROUND OF THE INVENTION

### 1. Field of the Invention

Embodiments of the invention relate generally to electric vehicles. More particularly, embodiments of the invention relate to a chassis design for optimizing the storage of batteries used in electric vehicles.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Electric vehicles have become more popular in recent years as many people look for alternatives in transportation, away from vehicles that require fossil fuels for operation. Government incentives further entice people in the move toward electric vehicles.

However, a current obstacle is the limited range of such electric vehicles when operating on a single charge. The worry about running out of charge provides a weight on consumers when deciding whether or not to purchase an electric vehicle.

In view of the foregoing, there is a need for an electric vehicle chassis design that can increase the space available for battery distribution, thus increasing the overall power available to the vehicle and, accordingly, increasing the range of the electric vehicle.

### SUMMARY OF THE INVENTION

Embodiments of the present invention aim to solve the aforementioned problems in conventional chassis design by providing an advanced chassis design that offers more battery storage spaces than conventional same-class electric vehicles. The chassis provides four battery storage spaces. The significance of these additional storage areas lies in their direct impact on extending the driving range of the vehicle. Taking into consideration today's travel and remote working trends, this chassis could keep drivers from worrying about recharging their electric vehicles, even when traveling to places with no charging stations.

Embodiments of the present invention provide a chassis for an electric vehicle comprising a main chassis frame extending along a longitudinal axis of the electric vehicle; an upper and lower battery compartment disposed within the main chassis frame, the upper battery compartment disposed above the lower battery compartment; and first and second side battery compartments attached to opposite sides of the main chassis frame.

Embodiments of the present invention provide a chassis for an electric vehicle comprising a main chassis frame extending along a longitudinal axis of the electric vehicle; an upper and lower battery compartment disposed within the main chassis frame, the upper battery compartment disposed above the lower battery compartment; first and second side battery compartments attached to opposite sides of the main chassis frame; first and second main chassis rails forming opposing sides of the main chassis frame, the first and second main chassis rails forming sides of the upper battery compartment; first and second lower compartment side rails disposed parallel to the first and second main chassis rails, the first and second lower compartment side rails forming sides of the lower battery compartment; a plurality of a first set of upper mounting holes formed in each of the first and second main chassis rails, each set spaced apart along sides of the upper battery compartment; a plurality of a second set of lower mounting holes formed in the first and second lower compartment side rails, each set disposed directly below a respective set of the plurality of the first set of upper mounting holes; and a plurality of side compartment attachment arms, each one of the plurality of side compartment attachment arms attached to aligned sets of the plurality of the first set of upper mounting holes and the plurality of the second set of lower mounting holes, the plurality of side compartment attachment arms forming a side portion of the each of the first and second side battery compartments.

Embodiments of the present invention provide a chassis for an electric vehicle comprising a main chassis frame extending along a longitudinal axis of the electric vehicle; an upper and lower battery compartment disposed within the main chassis frame, the upper battery compartment disposed above the lower battery compartment; and first and second side battery compartments attached to opposite sides of the main chassis frame, wherein the upper battery compartment is disposed directly above the lower battery compartment; the first and second side battery compartments are longitudinally aligned with the upper and lower battery compartments; and a lower support of the first and second side battery compartments is located above a lower support of the lower battery compartment and below a lower support of the upper battery compartment.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a perspective view of a vehicle chassis, having batteries disposed therein, according to an exemplary embodiment of the present invention;

FIG. 2 illustrates a front view of the vehicle chassis of FIG. 1;

FIG. 3 illustrates a back view of the vehicle chassis of FIG. 1;

FIG. 4 illustrates a bottom view of the vehicle chassis of FIG. 1;

FIG. 5 illustrates a side view of the vehicle chassis of FIG. 1;

FIG. 6 illustrates a top view of the vehicle chassis of FIG. 1;

FIG. 7 illustrates a cross-sectional view taken along line VII-VII of FIG. 6;

FIG. 8 illustrates a top view of the vehicle chassis of FIG. 1 without batteries disposed therein;

FIG. 9 illustrates a top perspective view of a side battery tray of the vehicle chassis of FIG. 1;

FIG. 10 illustrates a bottom perspective view of the side battery tray of FIG. 9;

FIG. 11 illustrates a top, perspective, detailed view of a central region of the main chassis structure of the vehicle chassis of FIG. 1;

FIG. 12 illustrates a bottom, perspective, detailed view of a central region of the main chassis structure of the vehicle chassis of FIG. 1;

FIG. 13 illustrates a front perspective view of a plate-type cross member of the vehicle chassis of FIG. 1;

FIG. 14 illustrates a back perspective view of a plate-type cross member of the vehicle chassis of FIG. 1; and

FIG. 15 illustrates a perspective view of a tube-type cross member of the vehicle chassis of FIG. 1.

The illustrations in the figures may not necessarily be drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide an electric vehicle chassis that can include multiple battery compartments specifically arranged therein. The chassis can include a main structure extending longitudinally along a length of the electric vehicle which it supports. The main structure can include a first, upper main structure battery compartment. A lower main structure frame can be disposed below the first, upper main structure battery compartment to provide a second, lower main structure battery compartment. Side battery compartments can be attached to opposite sides of the main structure frame to provide third and fourth, side battery compartments. Thus, the vehicle chassis can provide four distinctly positioned battery compartments for the placement of batteries for the electric vehicle, providing more battery storage spaces than conventional same-class electric vehicles.

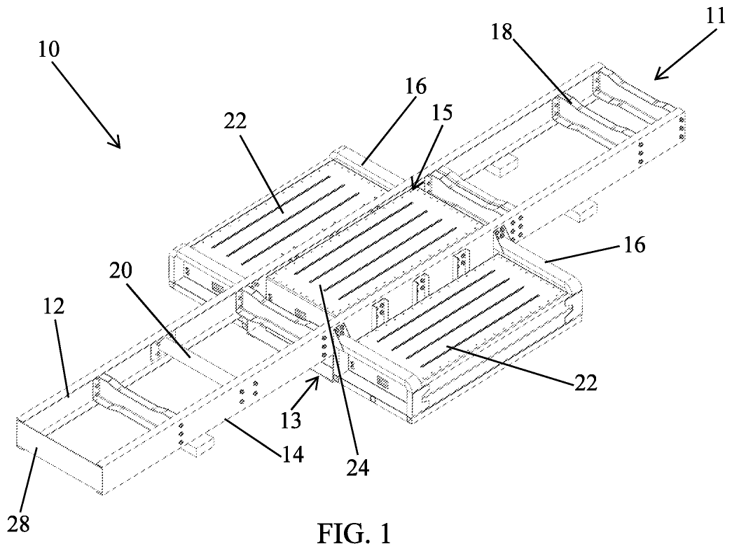

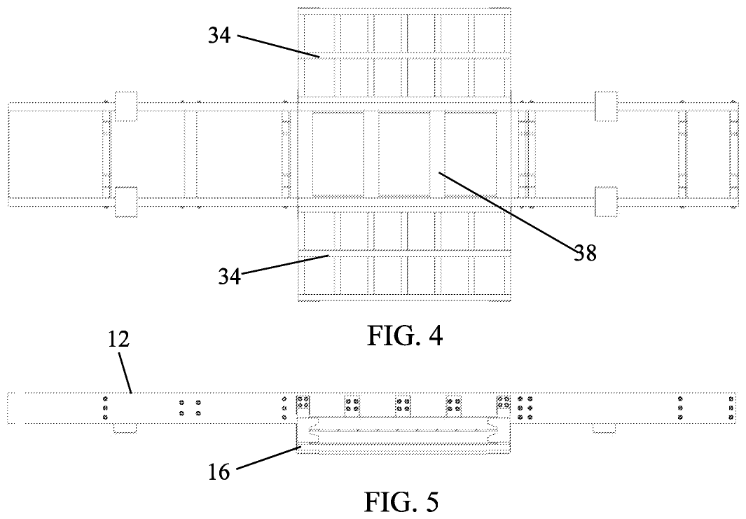

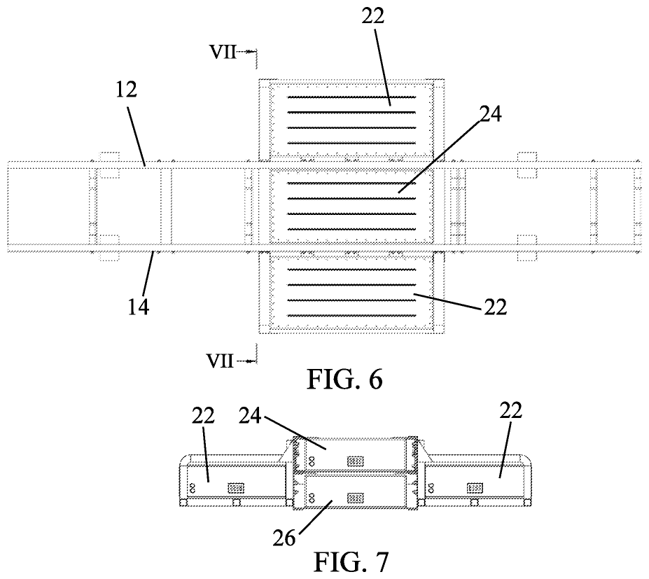

Referring to FIGS. 1 through 8, a vehicle chassis 10 may be designed for an electric vehicle, such as an all-electric vehicle, a plug-in hybrid electric vehicle, or the like. The chassis 10 can include a main chassis structure 11 formed by a first side main chassis rail 12 and a second side main chassis rail 14. Various cross members, as discussed in greater detail below, can span between the first and second side main chassis rails 12, 14, including a plate-type cross member 18, a tube-type cross member 20 and a front end cap 28.

A lower battery compartment 13 may be attached to the main chassis structure 11. Typically, the lower battery compartment 13 is immediately below an upper battery compartment 15 formed in the main chassis structure. Thus, an upper battery pack 24 can be disposed directly above a lower battery pack 26. The lower battery compartment 13 may be defined by first and second lower compartment rails 30, 32 that are longitudinally aligned with the first and second main chassis rains 12, 14. Thus, an exterior surface of the rails 12 and 30 are flush with each other, and an exterior surface of the rails 14, 32 are also flush with each other.

Side battery compartments 16 may be attached at each side of the main chassis structure 11. A first one of the side battery compartments 16 may attach to the rails 12, 30 at a first side of the main chassis structure 11 and a second one of the side battery compartments 16 may attach to the rails 14, 32 at a second side of the main chassis structure 11. The side battery compartments 16 may each house a side battery pack 22. Thus, four battery packs (upper battery pack 24, lower battery 26 and two side battery packs 22) can be disposed in the vehicle chassis 10.

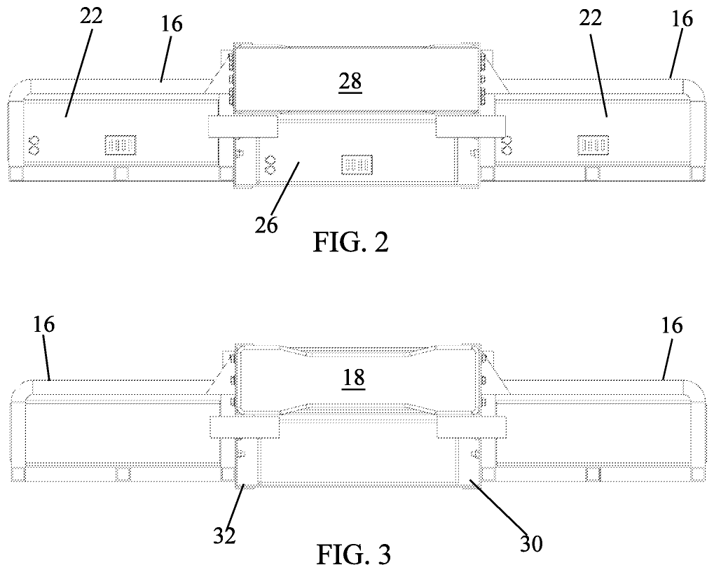

In some embodiments, the side battery compartments 16 can longitudinally align with the lower battery compartment 13 and the upper battery compartment 15. In other words, a forward and a rearward end of the side battery compartments 16 can be co-linear with a forward and rearward end of the upper and lower battery compartments 15, 13. In some embodiments, the side battery packs 22 may be supported at a height that is above a support height of the lower battery pack 26, but below a support height of the upper battery pack 24. This is best illustrated, for example, in FIGS. 2, 3 and 7. In some embodiments, the battery packs 22, 24, 26 may be disposed, longitudinally, in a central region of the vehicle chassis 10.

As shown in FIG. 4, the side battery compartments 16 can have a bottom support frame 34. The bottom support frame 34 can be operable to support the side battery pack 22 in the side battery compartment 16. In some embodiments, a grid design may be used for the bottom support frame 34. Of course other patterns, such as a diamond pattern, or the like, may be used for the bottom support frame 34. In some embodiments, a side plate member 40 may be disposed on top of the bottom support frame 34 to provide a solid surface for supporting the side battery pack 22.

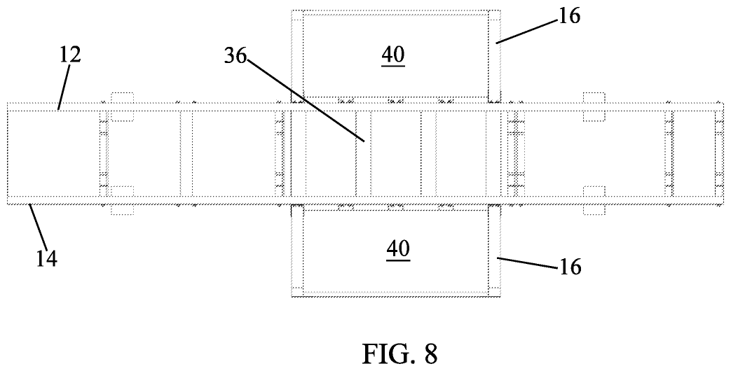

Similarly, a support frame 38 may be provided for the lower battery compartment 13. Further, as best seen in FIG. 8, a support frame 36 may be provided for the upper battery compartment 15. The support frames 38, 36 may be designed to support the lower battery pack 26 and the upper battery pack 24, respectively. While not shown, a plate member, similar to the plate member 40 used in the side battery compartments 16, may be used in each of the upper and lower battery compartments 15, 13.

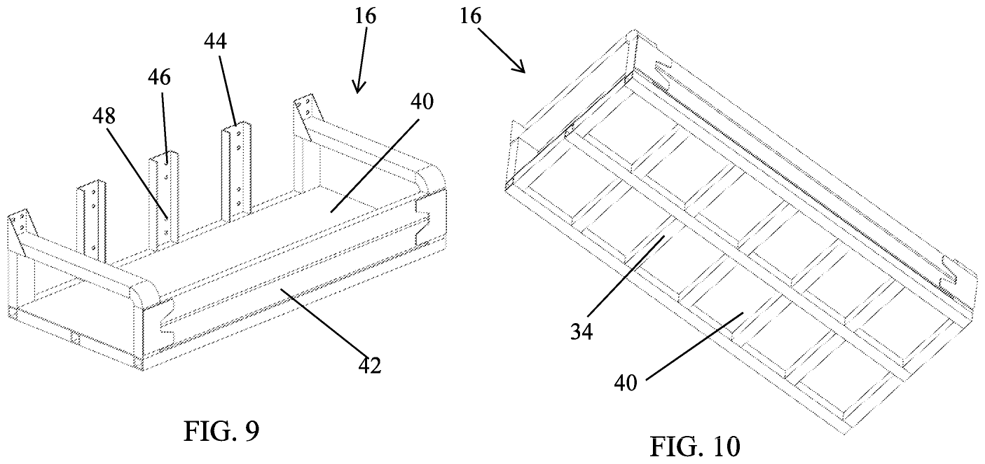

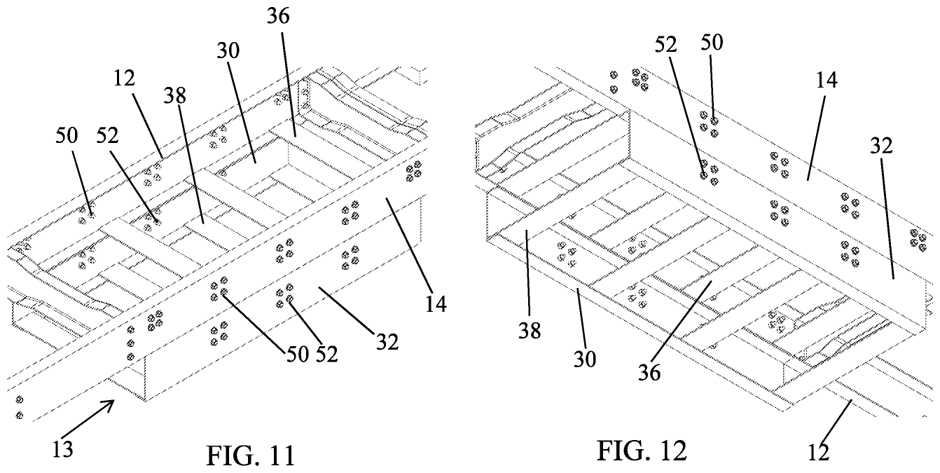

Referring now to FIGS. 9 through 12, details of the side battery compartments 16 and the central region of the main chassis structure 11 are shown. The side battery compartments 16 can include a front face 42 disposed along the outer sides of the side battery compartments 16. A plurality of attachment arms 44 may be disposed on an attachment side (opposite the front face 42) of the side battery compartments 16. The attachment arms 44 can include upper mounting holes 46 and lower mounting holes 48. The upper mounting holes 46 may align with mounting holes 50 formed in the first and second main chassis rails 12, 14. The lower mounting holes 48 may align with the mounting holes 52 formed in the first and second lower compartment rails 30, 32. Thus, the attachment arms 44 can not only support the side battery compartments 16, but also can interconnect the first and second main chassis rails 12, 14 with respective ones of the first and second lower compartment rails 30, 32.

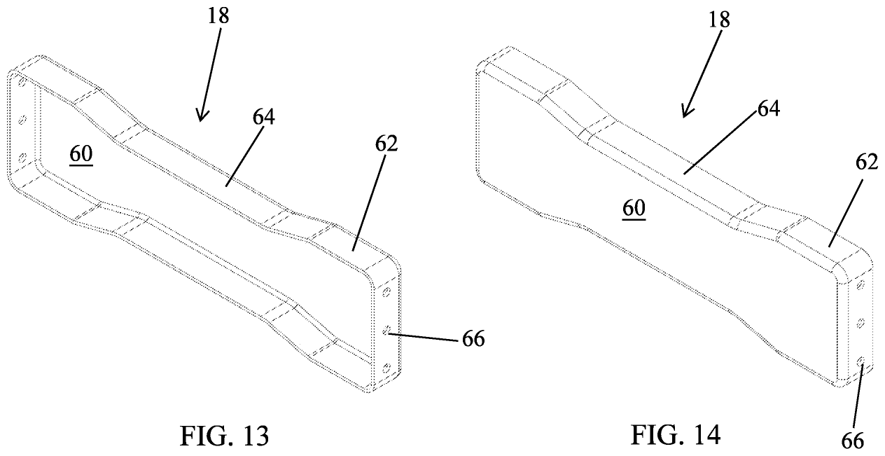

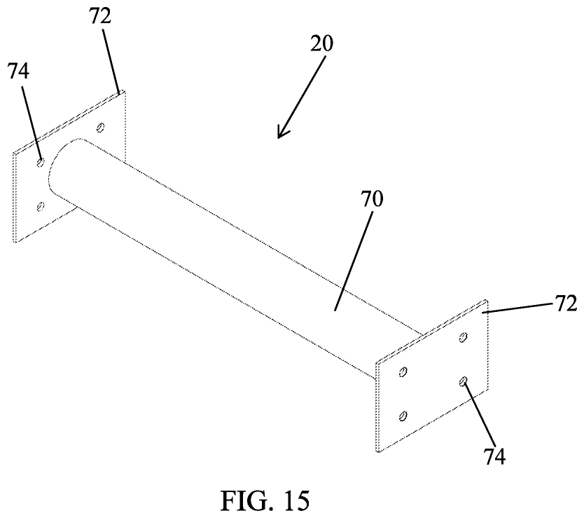

Referring now to FIGS. 13 and 14, the plate-type cross-members 18 are illustrated. A plate structure 60 may be formed on one end thereof, with a frame 62 surrounding the outer periphery of the plate structure 60. The frame 62 may extend, longitudinally, away from the plane of the plate structure 60 on only one side thereof. Sides of the frame 62 can include mounting holes 66 that can align with, and disposed directly adjacent to, mounting holes in the first and second main chassis rails 12, 14. In some embodiments, an axially central portion of the plate structure 60 may include a recess 64 on both the top and bottom thereof.

Referring now to FIG. 15, the type-type cross member 20 is illustrated. A central tube 70 can have attachment plates 72 disposed on each end thereof. The attachment plates 72 can include mounting holes 74 that can align with, and disposed directly adjacent to, mounting holes in the first and second main chassis rails 12, 14.

While the rails 12, 14, 30, 32 are illustrated as C-channels, it should be understood that other configurations of the rails may be used within the scope of the present invention, such as I-beams, L-beams, or the like.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A chassis for an electric vehicle comprising:
a main chassis frame extending along a longitudinal axis of the electric vehicle;
an upper and lower battery compartment disposed within the main chassis frame, the upper battery compartment disposed above the lower battery compartment; and
first and second side battery compartments attached to opposite sides of the main chassis frame.

2. The chassis of claim 1, wherein the upper battery compartment is disposed directly above the lower battery compartment.

3. The chassis of claim 1, wherein the first and second side battery compartments are longitudinally aligned with the upper and lower battery compartments.

4. The chassis of claim 3, wherein a lower support of the first and second side battery compartments is located above a lower support of the lower battery compartment and below a lower support of the upper battery compartment.

5. The chassis of claim 1, further comprising a battery pack in each of the upper and lower battery compartments and in the first and second side battery compartments.

6. The chassis of claim 1, wherein the first and second side battery compartments include a plurality of attachment arms, the attachment arms operable to fix the first and second side battery compartments to side rails of both of the upper and lower battery compartments.

7. The chassis of claim 1, further comprising first and second main chassis rails forming opposing sides of the main chassis frame, the first and second main chassis rails forming sides of the upper battery compartment.

8. The chassis of claim 7, further comprising first and second lower compartment side rails disposed parallel to the first and second main chassis rails, the first and second lower compartment side rails forming sides of the lower battery compartment.

9. The chassis of claim 8, wherein an outer surface of the first main chassis rail is co-planar with an outer surface of the first lower compartment side rail, and an outer surface of the second main chassis rail is co-planar with an outer surface of the second lower compartment side rail.

10. The chassis of claim 7, further comprising a plurality of plate-type cross members interconnecting the first and second main chassis rails.

11. The chassis of claim 7, further comprising one or more tube-type cross members interconnecting the first and second main chassis rails.

12. The chassis of claim 1, further comprising a bottom support frame disposed at a lower end of the first and second side battery compartments, the bottom support frame operable to support a battery pack disposed within the first and second side battery compartments.

13. The chassis of claim 12, further comprising a bottom plate member disposed on top of the bottom support frame.

14. The chassis of claim 1, further comprising first and second bottom support frames disposed at respective upper and lower battery compartments, the first and second bottom support frames operable to support battery packs disposed within the upper and lower battery compartments.

15. A chassis for an electric vehicle comprising:
a main chassis frame extending along a longitudinal axis of the electric vehicle;
an upper and lower battery compartment disposed within the main chassis frame, the upper battery compartment disposed above the lower battery compartment;
first and second side battery compartments attached to opposite sides of the main chassis frame;
first and second main chassis rails forming opposing sides of the main chassis frame, the first and second main chassis rails forming sides of the upper battery compartment;
first and second lower compartment side rails disposed parallel to the first and second main chassis rails, the first and second lower compartment side rails forming sides of the lower battery compartment;
a plurality of a first set of upper mounting holes formed in each of the first and second main chassis rails, each set spaced apart along sides of the upper battery compartment;
a plurality of a second set of lower mounting holes formed in the first and second lower compartment side rails, each set disposed directly below a respective set of the plurality of the first set of upper mounting holes; and
a plurality of side compartment attachment arms, each one of the plurality of side compartment attachment arms attached to aligned sets of the plurality of the first set of upper mounting holes and the plurality of the second set of lower mounting holes, the plurality of side compartment attachment arms forming a side portion of the each of the first and second side battery compartments.

16. The chassis of claim 15, wherein an outer surface of the first main chassis rail is co-planar with an outer surface of the first lower compartment side rail, and an outer surface of the second main chassis rail is co-planar with an outer surface of the second lower compartment side rail.

17. The chassis of claim 15, further comprising a bottom support frame disposed at a lower end of the first and second side battery compartments, the bottom support frame operable to support a battery pack disposed within the first and second side battery compartments.

18. The chassis of claim 15, further comprising first and second bottom support frames disposed at respective upper and lower battery compartments, the first and second bottom support frames operable to support battery packs disposed within the upper and lower battery compartments.

19. A chassis for an electric vehicle comprising:
a main chassis frame extending along a longitudinal axis of the electric vehicle;
an upper and lower battery compartment disposed within the main chassis frame, the upper battery compartment disposed above the lower battery compartment; and
first and second side battery compartments attached to opposite sides of the main chassis frame, wherein:
the upper battery compartment is disposed directly above the lower battery compartment;
the first and second side battery compartments are longitudinally aligned with the upper and lower battery compartments; and
a lower support of the first and second side battery compartments is located above a lower support of the lower battery compartment and below a lower support of the upper battery compartment.

20. The chassis of claim 19, further comprising a battery pack in each of the upper and lower battery compartments and in the first and second side battery compartments.
